(19) United States
(12) Patent Application Publication
(10) Pub. No.: US 2022/0147752 A1
(43) Pub. Date: May 12, 2022

(54) IMAGE STITCHING APPARATUS, IMAGE PROCESSING CHIP AND IMAGE STITCHING METHOD

(71) Applicant: SigmaStar Technology Ltd., Fujian (CN)

(72) Inventors: Wen-Yang LIAO, Zhubei City (TW); Ren-You HUANG, Zhubei City (TW); Dow-Chen HUANG, Zhubei City (TW)

(21) Appl. No.: 17/487,455

(22) Filed: Sep. 28, 2021

(30) Foreign Application Priority Data
Nov. 6, 2020 (CN) 202011231437.8

(51) Int. Cl. G06K 9/34; G06T 7/13; G06T 7/174; G06T 7/90; G06T 7/215; G06T 5/50; G06K 9/46

(52) U.S. Cl. CPC G06K 9/34; G06T 7/13; G06T 7/174; G06K 2009/2045; G06T 7/215; G06T 5/50; G06K 9/4604; G06T 7/90

(57) ABSTRACT

An image stitching apparatus, an image processing chip and an image stitching method are provided. The image stitching apparatus includes a motion detection circuit, a determination circuit and a stitching circuit. The motion detection circuit performs motion detection on an overlapping area between a first image and a second image that are to undergo stitching to obtain a motion area having a moving object in the overlapping area. The determination circuit calculates a target stitching line using a constraint of avoiding the motion area. The stitching circuit stitches the first image and the second image according to the target stitching line to obtain a stitched image.

This application claims the benefit of China application Serial No. CN202011231437.8, filed Nov. 6, 2020, the subject matter of which is incorporated herein by reference.

### BACKGROUND OF THE INVENTION

### Field of the Invention

The invention relates to an image processing technology, and more particularly to an image stitching apparatus, an image processing chip and an image stitching method.

### Description of the Related Art

Image stitching refers to merging two or more images into one image, so that the merged image includes more information for more convenient viewing for a user or processing for a computer. Image stitching is a critical direction of research in the technical field of image processing, and has profound application values. However, when image stitching is performed in related techniques, attention is frequently paid to only the visual difference between stitched images, causing unsatisfactory quality of the final stitched image obtained.

### SUMMARY OF THE INVENTION

In view of the issues of the prior art, it is an object of the present invention to provide an image stitching apparatus, an image processing chip and an image stitching method.

An image stitching apparatus provided by the present invention includes a motion detection circuit, a determination circuit and a stitching circuit. The motion detection circuit performs motion detection on an overlapping area between a first image and a second image that are to undergo stitching to obtain a motion area having a moving object in the overlapping area. The determination circuit calculates a target stitching line using a constraint of avoiding the overlapping area. The stitching circuit stitches the first image and the second image according to the target stitching line to obtain a stitched image.

An image processing chip further provided by the present invention includes an interface circuit, an area determination circuit and an image stitching apparatus. The interface circuit obtains a first image and a second image that are to undergo stitching. The area determination circuit determines an overlapping area between the first image and the second image. The image stitching circuit includes a motion detection circuit, a determination circuit and a stitching circuit. The motion detection circuit performs motion detection on the overlapping area between the first image and the second image to obtain a motion area having a moving object in the overlapping area. The determination circuit calculates a target stitching line using a constraint of avoiding the motion area. The stitching circuit stitches the first image and the second image according to the target stitching line to obtain a stitched image.

An image stitching method further provided by the present invention includes: performing motion detection on an overlapping area between a first image and a second image to obtain a motion area having a moving object in the overlapping area; calculating a target stitching line using a constraint of avoiding the motion area; and stitching the first image and the second image according to the target stitching line to obtain a stitched image.

Features, implementations and effects of the present application are described in detail with the accompanying drawings in the preferred embodiments below.

### BRIEF DESCRIPTION OF THE DRAWINGS

FIG. 1 is a first block diagram of an image stitching apparatus according to an embodiment of the present invention;

FIG. 2 is a diagram of an example of a motion area obtained by performing motion detection on an overlapping area between a first image and a second image by a motion detection circuit in FIG. 1 according to an embodiment of the present invention;

FIG. 3 is a diagram of an example of a target stitching line calculated by a determination circuit in FIG. 1 according to an embodiment of the present invention;

FIG. 4 is a diagram of an example of a stitched image obtained by stitching a first image and a second image according to the target stitching line in FIG. 3 by a stitching circuit in FIG. 1 according to an embodiment of the present invention;

FIG. 5 is a second block diagram of an image stitching apparatus according to an embodiment of the present invention;

FIG. 6 is a more detailed block diagram of a difference calculation circuit in FIG. 5 according to an embodiment of the present invention;

FIG. 7 is a diagram of an example of a color difference matrix obtained by a color difference calculation circuit in FIG. 6 according to an embodiment of the present invention;

FIG. 8 is a diagram of an example of an edge difference matrix obtained from edge detection performed by an edge detector in FIG. 6 and calculated by an edge difference calculation circuit in FIG. 6 according to an embodiment of the present invention;

FIG. 9 is a block diagram of a determination circuit in FIG. 5 according to an embodiment of the present invention;

FIG. 10 is an exemplary cost diagram obtained from calculation by a data processing circuit in FIG. 9 according to an embodiment of the present invention;

FIG. 11 is a diagram of an example of a stitching line calculation circuit in FIG. 9 calculating a target stitching line according to an embodiment of the present invention;

FIG. 12 is a diagram of another example of the stitching line calculation circuit in FIG. 9 calculating a target stitching line according to an embodiment of the present invention;

FIG. 13 is a third block diagram of an image stitching apparatus according to an embodiment of the present invention;

FIG. 14 is a schematic diagram of a motion area detected by the motion detection circuit in FIG. 1 according to an embodiment of the present invention;

FIG. 15 is a block diagram of an image processing chip according to an embodiment of the present invention; and

FIG. 16 is a flowchart of an image stitching method according to an embodiment of the present invention.

### DETAILED DESCRIPTION OF THE INVENTION

It should be noted that, the principle of the present invention is described by taking examples implemented in an appropriate application environment. The description provides specific exemplary embodiments of the present invention, and is not to be construed as limitations to other specific embodiments that are not described in detail herein.

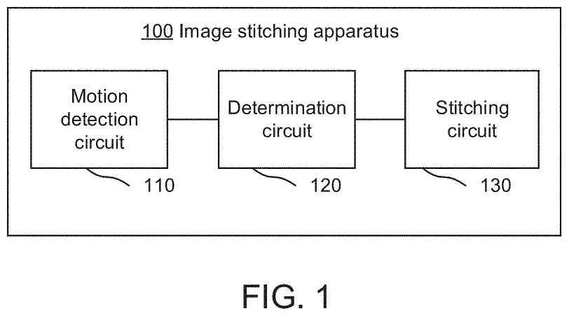

The technology provided by the embodiments of the present invention relates to the technical field of image processing, more particularly to image stitching, and is to be described in the embodiments below. FIG. 1 shows a first block diagram of an image stitching apparatus 100 according to an embodiment of the present invention. Referring to FIG. 1, the image stitching apparatus 100 may include a motion detection circuit 110, a determination circuit 120 and a stitching circuit 130 that are electrically coupled to one another. In practice, the motion detection circuit 110, the determination circuit 120 and the stitching circuit 130 may be implemented by hardware circuits coordinating with software.

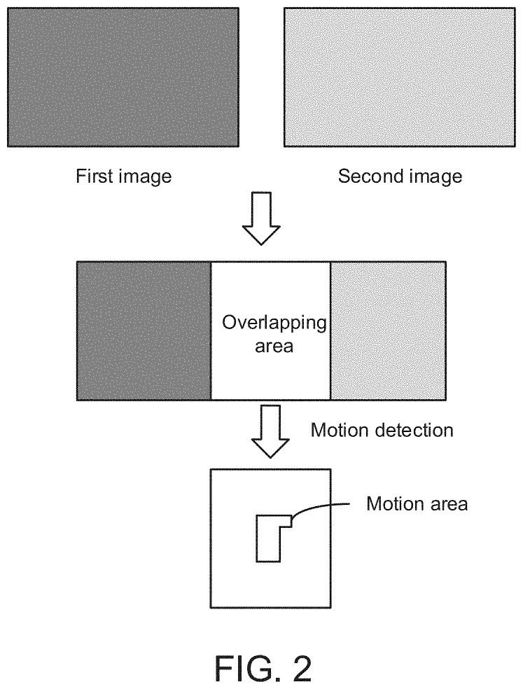

FIG. 2 shows a diagram of an example of a motion area obtained by performing motion detection on an overlapping area between a first image and the second image by the motion detection circuit 110 in FIG. 1 according to an embodiment of the present invention. Referring to FIG. 2, the motion detection circuit 110 is configured to perform motion detection on the overlapping area between the first image and the second image to thereby obtain a motion area having a moving object in the overlapping area, wherein the moving object may be any object with motion, and may include, for example but not limited to, a person or an object.

In an embodiment of the present invention, sources of the first image and the second image are not specifically defined. For example, the first image and the second image may be two images captured at different angles during a horizontal rotation process by the same camera having a partially overlapping field of view. Alternatively, the first image and the second image may be two images respectively captured by two cameras having a partially overlapping field of view.

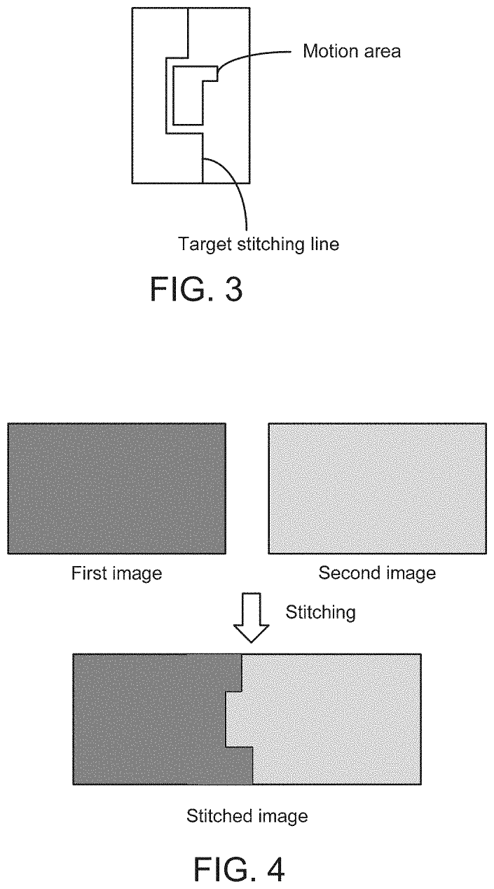

FIG. 3 shows a diagram of an example of a target stitching line calculated by the determination circuit 130 in FIG. 1. Referring to FIG. 3, the determination circuit 130 calculates, using a constraint of avoiding the motion area, a stitching line for stitching the first image and the second image, wherein in the stitching line referred to as a target stitching line.

FIG. 4 shows a diagram of an example of a stitched image obtained by stitching the first image and the second image according to the target stitching line in FIG. 3 by the stitching circuit 130 in FIG. 1 according to an embodiment of the present invention. As shown in FIG. 4, the image obtained by stitching the first image and the second image includes image contents of the first image and the second image, wherein the image contents in the stitched image on the left side of the stitching line are from the first image, and the image contents on the right side of the stitching line are from the second image.

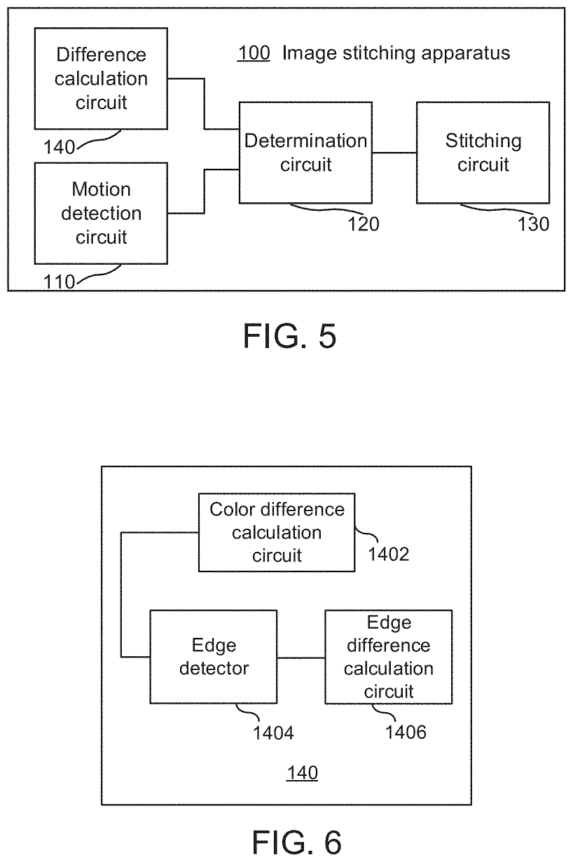

FIG. 5 shows a second block diagram of an image stitching apparatus 100 according to an embodiment of the present invention. Referring to FIG. 5, in one embodiment, the image stitching apparatus 100 further includes a difference calculation circuit 140, which is configured to calculate at least a difference matrix between the first image and the second image with respect to the overlapping area. Once the difference matrix is obtained, the determination circuit 120 is further configured to calculate the target stitching line using constraints of minimizing a difference between two sides of the stitching line and avoiding the motion area according to the matrix difference.

It should be noted that, the difference matrix calculated by the difference calculation circuit 140 is for describing the difference of each position in the overlapping area between the first image and the second image, wherein the difference may be a difference between pixels or may be a difference between pixel blocks formed by multiple pixels. The difference between the first image and the second image calculated by the difference calculation circuit 140 may be one or more of a color difference, a grayscale difference and an edge difference. For example, the difference calculation circuit 140 is configured to calculate a color difference between pixels, and calculate a color matrix difference between the first image and the second image with respect to the overlapping area between the first image and the second image, wherein the color difference matrix is for describing a color difference between two pixels on the same positions in the overlapping area between the first image and the second image.

As described above, after the difference calculation circuit 140 calculates the difference matrix and the motion detection circuit 110 detects the motion area, the determination circuit 130 calculates and obtains the target stitching line using the constraints of minimizing the difference between the two sides of the stitching line and avoiding the motion area according to the difference matrix. Thus, when the stitching circuit 130 stitches the first image and the second image according to the target stitching line, the difference between the image contents of the obtained stitched image on both left and right sides of the target stitching line is minimized, and the target stitching line may not pass through any moving object, further enhancing image stitching quality.

In one embodiment, the difference calculation circuit 140 is configured to calculate multiple different types of difference matrices for the first image and the second image with respect to the overlapping area according to multiple different difference calculation methods.

FIG. 6 shows a more detailed block diagram of the difference calculation circuit 140 in FIG. 5 according to an embodiment of the present invention. Referring to FIG. 6, in one embodiment, the difference calculation circuit 140 includes a color difference calculation circuit 1402, an edge detector 1404 and an edge difference calculation circuit 1406. The color difference calculation circuit 1402 calculates the color difference of each group of pixels on the same positions in the first image and the second image with respect to the motion area, so as to obtain a color difference matrix describing the color difference between pixels on the same positions in the overlapping area between the first image and the second image. Alternatively, by configuring the color difference calculation circuit 1402, the color difference calculation circuit 1402 partitions the overlapping area between the first image and the second image into multiple pixel blocks (with each pixel block including multiple pixels), and calculates the color difference between the pixel blocks on the same positions in the overlapping area between the first image and the second image (for the same pixel block, merging color values of all pixels in the pixel block to obtain a merged color value for calculating the color difference, for example, calculating an average color value of all pixels for each color channel), so as to obtain the color difference matrix describing the color difference between the pixel blocks on the same positions in the overlapping area between the first image and the second image.

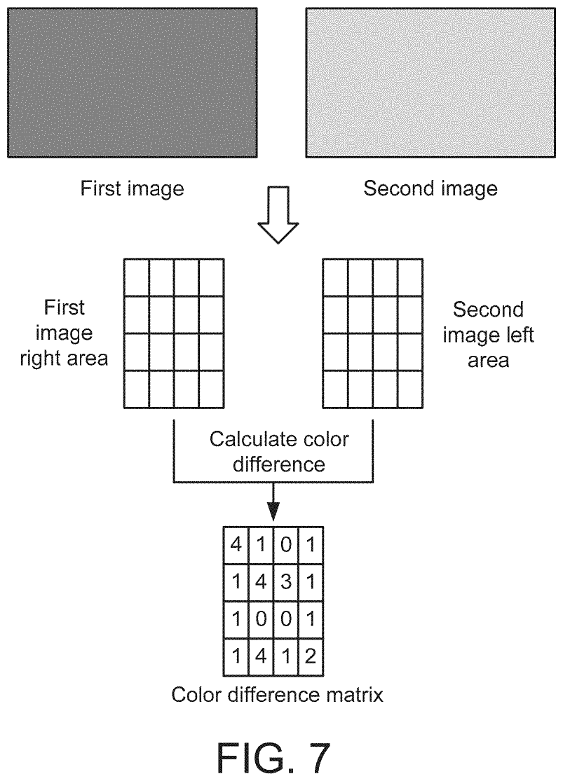

Referring to FIG. 7, FIG. 7 shows an example of a diagram of a color difference matrix calculated by the color difference calculation circuit 1402 in FIG. 6 according to an embodiment of the present invention. The overlapping area between the first image and the second image includes a first image right area and a second image left area. To calculate the color difference, the color difference calculation circuit 1402 evenly partitions each of the first image right area and the second image left area into a total of 4×4=16 pixel blocks. The color difference calculation circuit 1402 then calculates the color difference for each group of pixel blocks on the same positions of the first image right area and the second image left area. The pixel block on the upper-left corner of the first image right area and the pixel block on the upper-left corner of the second image left area are considered one group of pixel blocks on the same positions. Assume that the pixel values of the red channel, green channel and blue channel of the pixel block on the upper-left corner of the first image right area are 56, 255 and 251, respectively, and the pixel values of the red channel, green channel and blue channel of the pixel block on the upper-left corner of the second image left area are 52, 253 and 250, respectively. The color difference calculation circuit 1402 calculates absolute differences of the red channel, green channel and blue channel of this group of pixel blocks to obtain 4, 2 and 1 as the results, and uses the largest value 4 as the difference value of this group of pixel blocks.

According to the calculation method above, the color difference calculation circuit 1402 calculates the color difference between the remaining pixel blocks on the same positions in the overlapping area between the first image and the second image, and accordingly forms the color difference matrix shown in FIG. 7 from the differences corresponding to different pixel blocks.

The edge detector 1404 performs edge detection on the overlapping area between the first image and the second image to generate a first edge detection result and a second edge detection result, respectively. In practice, the edge detector 1404 may detect edges of an object in the image by analyzing the change or correspondence between pixel values of each pixel and peripheral pixels thereof in an image.

The edge difference calculation circuit 1406 may be configured to calculate an edge difference between each group of pixels or pixel blocks on the same positions in the overlapping area between the first image and the second image according to the first edge detection result and the second edge detection result, so as to obtain an edge difference matrix describing the edge difference between the pixels or pixel blocks on the same positions in the overlapping area between the first image and the second image. When the pixel block is used as a calculation foundation, a merged edge value obtained by merging the edge values of all pixels in the pixel block is obtained for one pixel block, for example, an average edge value of all pixels in the pixel block.

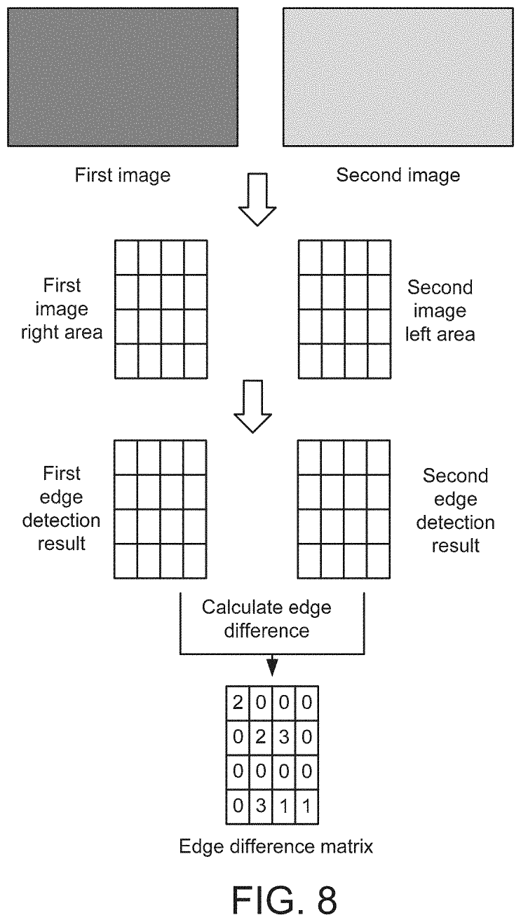

For example, FIG. 8 shows a diagram of an example of an edge difference matrix obtained from edge detection performed by an edge detector in FIG. 6 and calculated by an edge difference calculation circuit in FIG. 6 according to an embodiment of the present invention. The overlapping area between the first image and the second image includes a first image right area and a second image left area. To calculate the edge difference, the edge difference calculation circuit 1406 similarly evenly partitions, according to the similar partitioning method, each of the first image right area and the second image left area into a total of 4×4=16 pixel blocks. Then, the edge difference calculation circuit 1406 calculates the edge difference between each group of pixel blocks on the same positions in the first image right area and the second image left area. For example, for the pixel block on the upper-left corner of the first image right area and the pixel block on the upper-left corner of the second image left area considered the same group of pixel blocks, a difference of 2 is obtained.

According to the calculation method above, the edge difference calculation circuit 1406 calculates the edge difference between the remaining pixel blocks on the same positions in the overlapping area between the first image and the second image, and accordingly forms the edge difference matrix shown in FIG. 8 from the differences corresponding to different pixel blocks, wherein the edge difference matrix describes the edge difference between the pixel blocks on each same position in the overlapping area between the first image and the second image.

In an embodiment of the present invention, by configuring the color difference calculation circuit 1402 and the edge difference calculation circuit 1406, the shapes of the color difference matrix obtained by the color difference calculation circuit 1402 and the edge difference matrix obtained by the edge difference calculation circuit 1406 are the same. For example, by configuring both the difference calculation circuit 1402 and the edge difference calculation circuit 1406 to use pixels or pixel blocks (the pixel blocks are partitioned by the same partitioning method) as the target of the difference calculation, the shapes of the edge difference matrix and the color difference matrix obtained by calculation of the two are the same.

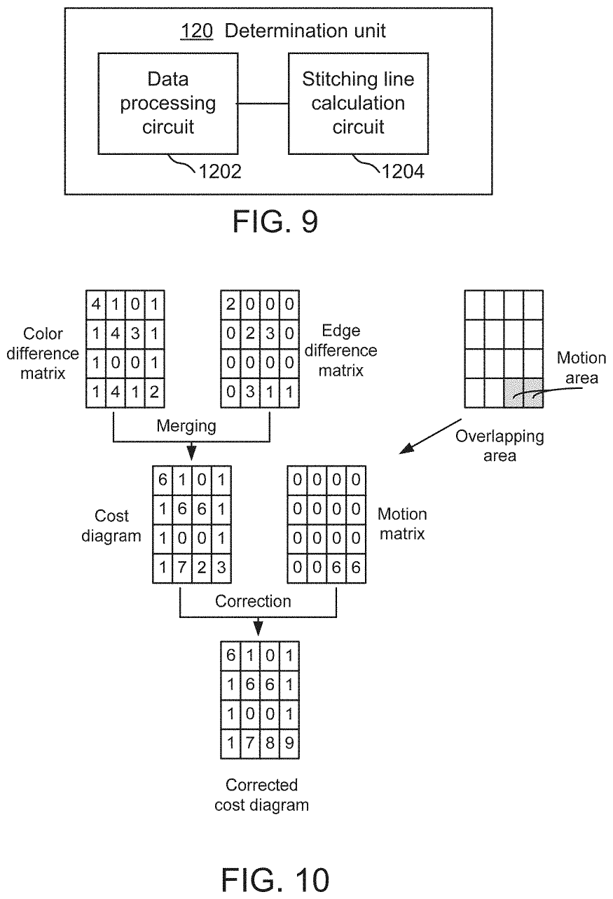

FIG. 9 shows a block diagram of the determination circuit 120 according to an embodiment of the present invention. Referring to FIG. 9, the determination circuit 120 is formed by two parts, which are respectively a data processing circuit 1202 and a stitching line calculation circuit 1204. To effectively utilize the obtained differences in different aspects of the overlapping area between the first image and the second image, the data processing circuit 1202 first merges the color difference matrix and the edge difference matrix, and uses the merged difference matrix containing both the color difference and the edge difference as a cost diagram for calculating the stitching line. Moreover, in order to have the obtained target stitching line to better avoid the motion area, the data processing circuit 1202 further adds a penalty cost to an element on a position in the cost diagram according to the motion area previously detected, so as to suppress the probability of the stitching line passing through the motion area in the overlapping area. That is, to say, the data processing circuit 1202 further corrects the cost diagram according to the motion area so as to obtain a corrected cost diagram. Details for merging the color difference matrix and the edge difference matrix and specific values of the penalty cost are not specifically defined herein, and may be configured by a person skilled in the art according to actual requirements. It is to be understood that, the probability that the stitching line successfully is avoided from the motion area increases as the value of the penalty cost gets larger.

For example, the approach for merging the color difference matrix and the edge difference matrix may be configured as directly adding elements on corresponding positions, and configuring a value 6 as the penalty cost. FIG. 10 shows an exemplary cost diagram calculated by the data processing circuit 1202 in FIG. 9 according to an embodiment of the present invention. Referring to FIG. 10, assuming that the motion area is the area of two pixel blocks on the lower-right corner of the overlapping area, the data processing circuit 1202 generates a motion matrix according to the motion area, wherein an element in a value 0 in the motion matrix means that the pixel block on the corresponding position in the overlapping area is a non-motion area, and an element having a penalty cost in a value 6 means that the pixel block on the corresponding position in the overlapping area is a motion area. As shown in FIG. 10, the data processing circuit 1202 directly adds the elements on the corresponding positions in the color difference matrix and the edge difference matrix to obtain a cost diagram, then directly adds the elements on the corresponding positions in the cost diagram and the motion matrix to add the penalty cost of the cost diagram, and obtains the final corrected cost diagram.

In one embodiment, the data processing circuit 1202 is configured to perform weighted addition on the elements on the corresponding positions in the color difference matrix and the edge difference matrix to obtain a cost diagram. For example, using of a constraint that the sum of the weights of the color difference matrix and the edge difference matrix is equal to 1, a person skilled in the art may allocate weights to the color difference matrix and the edge difference matrix according to actual requirements. It should be understood that, if the weight allocated to the color difference matrix is larger, the color difference of the overlapping area between the first image and the second image affects by a larger extent the calculation for the target stitching line; similarly, if the weight allocated to the edge difference matrix is larger, the edge difference of the overlapping area between the first image and the second image affects by a larger extent the calculation for the target stitching line.

After the cost diagram is obtained, the stitching line calculation circuit 1204 may use a least cost method to calculate a least cost stitching line according to the cost diagram, and use the least cost stitching line as the target stitching line for stitching the first image and the second image.

In one embodiment, the stitching line calculation circuit 1204 accumulates multiple elements in the cost diagram and an element in adjacent elements of an adjacent column using a constraint of a minimizing an accumulation value to obtain the target stitching line.

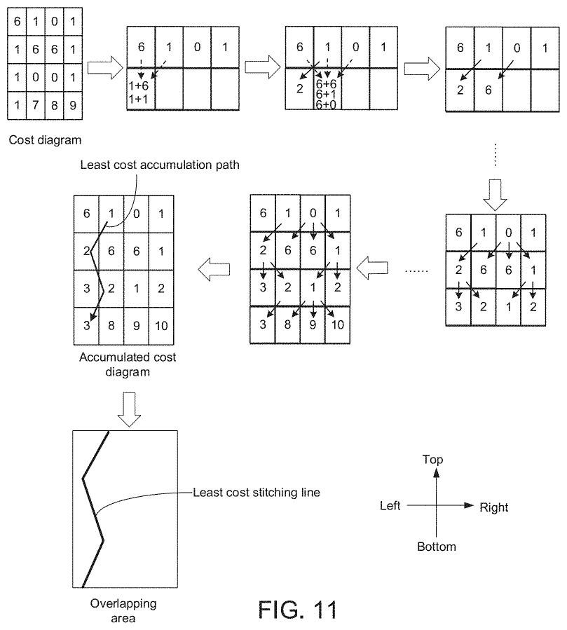

For example, FIG. 11 shows a diagram of an example of the stitching line calculation circuit 1204 in FIG. 9 calculating a target stitching line according to an embodiment of the present invention. The stitching line calculation circuit 1204 first determines according to the overlapping area between the first image and the second image an accumulation direction for performing cost accumulation. Assuming that the first image and the second image overlap in a right-left manner, the stitching line calculation circuit 1204 may selectively use a top-to-bottom direction as the accumulation direction, or a bottom-to-top direction as the accumulation direction; the top-to-bottom direction is selected as the accumulation direction herein for illustration.

After the accumulation direction is determined, the stitching line calculation circuit 1204 determines starting-row elements and ending-row elements in the cost diagram according to the accumulation direction. Again referring to FIG. 11, according to the foregoing accumulation direction, the horizontal row “6, 1, 0, 1” of the corrected cost diagram is the first horizontal row and no accumulation target thereof exists, and so the horizontal row “6, 1, 0, 1” is correspondingly used as an initial row of a cost accumulation diagram, the horizontal row “1, 6, 6, 1” is used as starting-ow elements, and the horizontal row “1, 7, 8, 9” is used as ending-row elements. That is, the second-row elements in the accumulation direction are set as the starting-row elements, and the last-row elements in the accumulation direction are set as the ending-row elements.

After the conversion of the stating-row elements and the ending-row elements is determined, for each element in the starting-row elements, the stitching line calculation circuit 1204 selects, using the constraint of the minimizing the accumulation cost (that is, a minimum accumulation value), a target element from elements of an adjacent row in a direction opposite to the accumulation direction to perform cost accumulation. For a row of elements accumulated, in addition to searching for the target element from, except of the two elements on both ends, two adjacent elements in adjacent-row elements, other elements including three adjacent elements in the adjacent-row elements in a direction opposite to the accumulation direction are also searched for the target element. Again referring to FIG. 11, for “1” on the left end of the starting-row elements, two adjacent elements “6, 1” in the adjacent-row elements “6, 1, 0, 1” in the direction opposite to the accumulation direction are searched for the target element, and at this point, “1” is selected as the target element for accumulation to obtain “2” as the accumulation cost and “1”-“2” (as shown by the solid arrow in FIG. 11) as the corresponding accumulation path. For “6” in the starting-row elements (the first “6” from left to right herein), three adjacent elements “6, 1, 0” in the adjacent-row elements “6, 1, 0, 1” in the direction opposite to the accumulation direction are searched for the target element, and at this point, “0” is selected as the target element for accumulation to obtain “6” as the accumulation cost and “0”-“6” as the corresponding accumulation path. The process above is performed similarly to complete the cost accumulation of the starting-row elements, and the corresponding accumulation cost is “2, 6, 6, 1”.

Similarly, the stitching line calculation circuit 1204 continues the cost accumulation on adjacent-row elements (that is, the third-row elements from top to bottom in this drawing) in the accumulation direction of the starting-row elements to obtain the corresponding accumulation cost as shown by the third-row elements from top to bottom in the cost accumulation diagram shown in FIG. 11, as “3, 2, 1, 2”. Accumulation is performed similarly up to the end-row elements (that is, the fourth-row elements from top to bottom in the cost diagram).

Finally, 16 elements similarly in 4 row horizontal rows and 4 vertical columns in the cost accumulation diagram are obtained, wherein the 16 elements are sequentially from top to bottom “6, 1, 0, 1”, “2, 6, 6, 1”, “3, 2, 1, 2” and “3, 8, 9, 10”. Correspondingly, the stitching line calculation circuit 1204 generates a least cost stitching line according to the accumulation path (“1”-“2”-“2”-“3” at this point) of the least accumulation cost, as shown in FIG. 11.

In another embodiment, the stitching line calculation circuit 1204 accumulates, by using the constraint of minimizing the accumulation value in an accumulation direction, multiple elements in the cost diagram and an element in adjacent elements of the same row and the adjacent row to obtain the target stitching line. One difference from the foregoing embodiment is that, in the process of selecting a target element for cost accumulation, the stitching line calculation circuit 1204 in this embodiment selects from adjacent elements of the same row and the adjacent row instead of only from adjacent elements of the adjacent row.

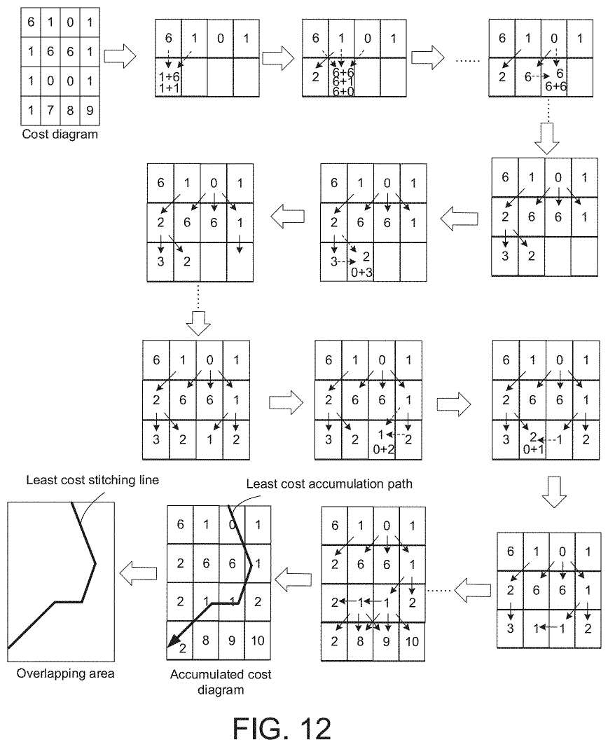

FIG. 12 shows a diagram of another example of the stitching line calculation circuit 1204 in FIG. 9 calculating a target stitching line according to an embodiment of the present invention. In this embodiment, the top-to-bottom direction is taken as an example of the accumulation direction for description. As the embodiment described above, the horizontal row “1, 6, 6, 1” is set as the starting-row elements, the horizontal row “1, 7, 8, 9” is set as the ending-row elements.

Again referring to FIG. 12, for “1” on the left end of the starting-row elements, two adjacent elements “6, 1” in the adjacent-row elements “6, 1, 0, 1” in a direction opposite to the accumulation direction are searched for the target element, and at this point, “1” selected as the target element for accumulation to obtain “2” as the accumulation cost, and “1”-“2” (as shown by the solid arrow in FIG. 12) as the corresponding accumulation path. Then, the stitching line calculation circuit 1204 further updates the accumulation cost in a first perpendicular direction of the accumulation direction, that is, updating the accumulation cost of adjacent elements of the same row. The left-to-right direction is taken as an example of the first vertical direction for description. At this point, “1” does not have any left adjacent element, the accumulation cost is not updated, and the accumulation cost “2” is preserved.

For “6” (the first “6” from left to right herein) on the left of the starting-row elements, three adjacent elements “6, 1, 0” in the adjacent-row elements “6, 1, 0, 1” in the direction opposite to the accumulation direction are searched for the target element, and at this point, “0” is selected as the target element for accumulation to obtain “6” as the accumulation cost and “0”-“6” as the corresponding accumulation path. Then, the stitching line calculation circuit 1204 updates the accumulation cost in a first perpendicular direction (a left-to-right direction at this point) of the accumulation direction. At this point, the left adjacent element of “6” is “1”; the stitching line calculation circuit 1204 determines whether the accumulation cost corresponding to “6” is greater than the sum of the accumulation cost corresponding to “1” and the cost of “6”, and if so, the accumulation cost corresponding to “6” is replaced by the sum of the accumulation cost corresponding to “1” and the cost of “6”. As shown, the accumulation cost corresponding to “6” is 6, which is smaller than the sum (8) of the accumulation cost (2) corresponding to “1” and the cost (6) of “6”, and thus the accumulation cost corresponding to “6” is not replaced.

Similarly, after all the elements in the first perpendicular direction are completely updated, the accumulation cost corresponding to the starting-row elements is “2, 6, 6, 1”. At this point, the stitching line calculation circuit 1204 again updates the accumulation cost of each element in a second perpendicular direction (the right-to-left direction at this point) opposite to the first perpendicular direction according to the reverse adjacent elements in the second perpendicular direction. For “1” on the right end of the starting-row elements, “1” does not have any right adjacent element, and the accumulation cost of “1” is thus not updated, and the accumulation cost “1” is preserved. For “6” (the second “6” from left to right herein) on the right of the starting-row elements, the right adjacent element of “6” at this point is “1”; the stitching line calculation circuit 1204 determines whether the accumulation cost corresponding to “6” is greater than a sum of the accumulation cost corresponding to “1” and the cost of “6”, and if so, replaces the accumulation cost corresponding to “6” by the sum of the accumulation cost corresponding to “1” and the cost of “6”. As shown in FIG. 12, the accumulation cost corresponding to “6” is 6, which is smaller than the sum 7 of the accumulation cost corresponding to “1” and the cost of “6”, and so the accumulation cost corresponding to “6” is not replaced. Similarly, the accumulation costs of the starting-row elements in the second perpendicular direction are updated, and the final obtained accumulation cost corresponding to the starting-row elements is still “2, 6, 6, 1”.

As described above, the stitching line calculation circuit 1204 continues the cost accumulation on the adjacent-row elements (that is, the third-row elements “1, 0, 0, 1” from top to bottom in the cost diagram) in the accumulation direction of the starting-row elements, and also updates the adjacent elements of the same row in the first perpendicular direction and the second perpendicular direction. Thus, the accumulation is performed up to the ending-row elements (the fourth-row elements from top to bottom in the cost diagram). Finally, a total of 16 elements similarly in 4 horizontal rows and 4 vertical columns in the cost accumulation diagram are obtained, wherein the 16 elements are sequentially from top to bottom “6, 1, 0, 1”, “2, 6, 6, 1”, “2, 1, 1, 2” and “2, 8, 9, 10”, respectively. Correspondingly, the stitching line calculation circuit 1204 generates a least cost stitching line according to the accumulation path (“0”-“1”-“1”-“1”-“1”-“2” at this point), as shown in FIG. 12.

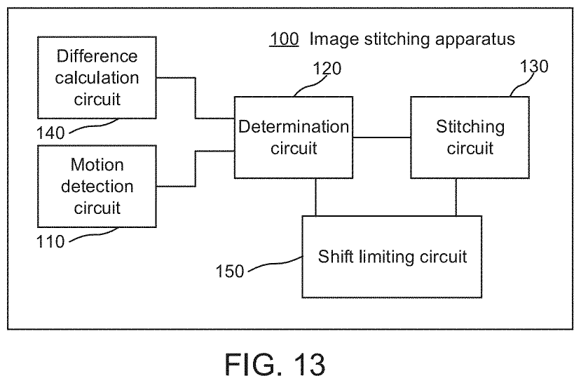

FIG. 13 shows a third block diagram of an image stitching apparatus 100 according to an embodiment of the present invention. Referring to FIG. 13, the image stitching apparatus 100 further includes a shift limiting circuit 150 for acquiring a previous stitching line calculated by the stitching line calculation circuit 1204 and generating shift limit data according to the previous stitching line. The determination circuit 120 then calculates the target stitching line using the constraint of avoiding the motion area according to at least one difference matrix described above and the shift limit data. By taking into account of the shift limit data associated with the previous stitching line, an overly large difference between the calculated target stitching line of the current image and the previous stitching line of a previous image is prevented and hence avoiding affected continuity of the images.

More specifically, the shift limiting circuit 150 can determine a motion cost with respect to a distance of each element from the previous stitching line, for example, generating corresponding shift limit data using the constraint that a determined shift cost gets larger as the distance increases. The data processing circuit 1202 in the determination circuit 120 then corrects the cost diagram according to the shift limit data.

For example, assume a first camera and a second camera have a partially overlapping field of view, and both the first camera and the second camera are in a capturing mode and continuously perform image capturing. At a starting timing t0 when the first camera and the second camera start capturing, an image captured by the first camera at the timing t0 is used as the first image, and an image captured by the second camera at the timing tO is used as the second image. Since no previous first image or previous second image exist at this point, the stitching line calculation circuit 1204 calculates, after the cost is obtained from merging performed by the data processing circuit 1202, a least cost stitching line according to the cost diagram, as the target stitching line for stitching the first image and the second image of the timing t0. At a next timing t1 of the timing tO, an image captured by the first camera at the timing t1 is used as the first image, and an image captured by the second camera at the timing t1 is used as the second image. At this point, the previous first image is the image captured by the first camera at the timing t0, and the previous second image is the image captured by the second camera at the timing t0; correspondingly, the previous stitching line is the stitching line calculated by the stitching line calculation circuit 1204 according to the previous first image and the previous second image. The shift limiting circuit 150 generates corresponding shift limit data according to the previous stitching line. The data processing circuit 1202 may comprehensively consider the color difference matrix, the edge difference matrix, the motion matrix and the shift limit data to generate the final cost diagram. For example, after obtaining a cost diagram according to the color difference matrix, the edge difference matrix and the motion matrix as shown in FIG. 10, the data processing circuit 1202 may correct the cost diagram according to the shift limit data, and the approach for such correction may be adding the cost value of each element in the cost diagram with the motion cost corresponding to each element in the shift limit data. Correspondingly, the stitching line calculation circuit 1204 then calculates the target stitching line according to the corrected cost diagram.

In one embodiment, the motion detection circuit 110 is configured to perform motion detection on the first image with respect to the overlapping area to obtain a first candidate motion area, perform motion detection on the second image with respect to the overlapping area to obtain a second candidate motion area, and merge the first candidate motion area and the second motion area to obtain the motion area.

It should be noted that, the motion detection method adopted by the motion detection circuit 110 may be configured by a person skilled in the art according to actual requirements, and is not specifically defined herein.

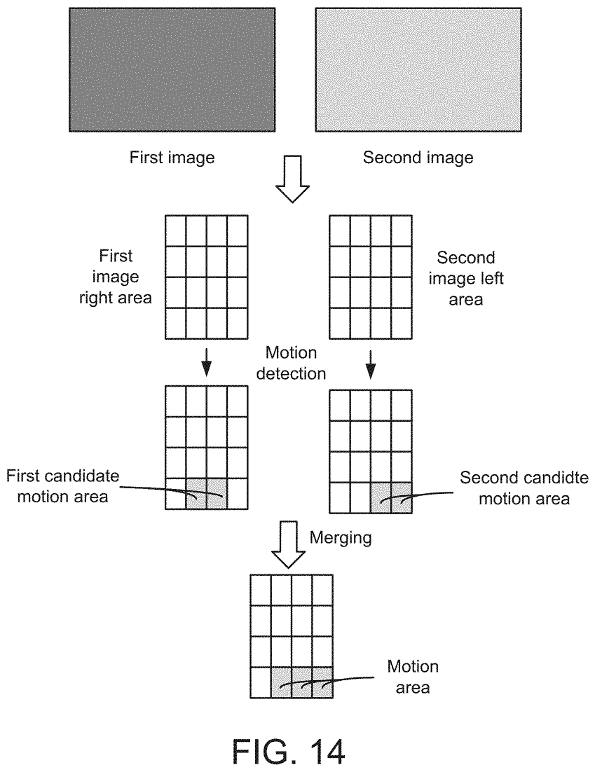

For example, FIG. 14 shows a schematic diagram of a motion area obtained from detection by the motion detection circuit 110 in FIG. 1 according to an embodiment of the present invention. Referring to FIG. 14, an overlapping area between the first image and the second image includes a first image right area and a second image left area. Each of the first image right area and the second image left area is partitioned into a total of 4×4=16 pixel blocks using the same partitioning method. For the first image, the first candidate motion area detected by the motion detection circuit 110 consists of 2 pixel blocks shown in FIG. 14; for the second image, the second candidate motion area detected by the motion detection circuit 110 consists of 2 pixel blocks shown in FIG. 14. Correspondingly, the motion detection circuit 110 merges the first candidate motion area and the second candidate motion area to obtain the motion area consisting of 3 pixel blocks shown in FIG. 14.

In one embodiment, the motion detection circuit 110 is configured to acquire a previous first image having the same field of view as the first image, calculate a pixel grayscale difference between the first image and the previous first image with respect to the overlapping area, and detect the first candidate motion area according to the pixel grayscale difference.

For example, assume a first camera and a second camera have a partially overlapping field of view, and both the first camera and the second camera are in a capturing mode and continuously perform image capturing.

At a starting timing t0 when the first camera and the second camera start capturing, an image captured by the first camera at the timing t0 is used as the first image, and an image captured by the second camera at the timing t0 is used as the second image. Since no previous first image or previous second image exists at this point, no detection for the motion area is performed.

At a next timing t1 of the timing t0, an image captured by the first camera at the timing t1 is used as the first image, and an image captured by the second camera at the timing t1 is used as the second image. At this point, the previous first image is the image captured by the first camera at the timing t0, and the previous second image is the image captured by the second camera at the timing t0. Correspondingly, the motion detection circuit 110 calculates the pixel grayscale difference between the first image and the previous first image with respect to the overlapping area, and detects the first candidate motion area according to the pixel grayscale difference.

Similarly, at timings subsequent to the timing t1, the motion detection circuit 110 performs motion detection according to the method above.

In one embodiment, the motion detection circuit 110 is configured to partition the overlapping area into multiple sub-blocks, merge the pixel grayscale difference in each sub-block to obtain a merged grayscale difference, and generate the first candidate motion area according to the sub-block having a merged grayscale difference greater than a predetermined threshold. The specific value of the predetermined threshold may be configured by a person skilled in the art according to actual requirements, and is not specifically defined herein.

In an optional embodiment, the motion detection circuit 110 is configured to calculate an average grayscale difference of the pixel grayscale difference in each sub-block, and use the average grayscale difference of each sub-block as the merged grayscale difference of each sub-block.

It should be noted that, the motion detection method performed by the motion detection circuit 110 on the second image may be referred from the motion detection method performed by the motion detection circuit 110 on the first image and be correspondingly implemented, and associated details are omitted herein.

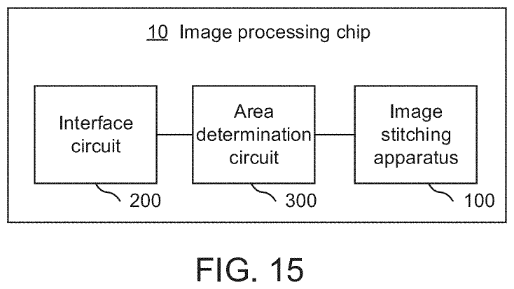

FIG. 15 shows a block diagram of an image processing chip 15 according to an embodiment of the present invention. Referring to FIG. 15, the present invention further provides an image processing chip 10 including an interface circuit 200, an area determination circuit 300 and an image stitching apparatus 100. The interface circuit 200 is for acquiring a first image and a second image that are to undergo image stitching. The area determination circuit 300 is for determining an overlapping area between the first image and the second image. The image stitching apparatus 100 is for stitching the first image and the second image according to the overlapping area to obtain a stitched image.

For example, the interface circuit 200 may be a Mobile Industry Processor Interface (MIPI). The interface circuit 200 is capable of receiving image data; for example, the interface circuit 200 is capable of receiving two images captured at different angles during a horizontal rotation process by the same camera having a partially overlapping field of view, or may be two images respectively captured by two cameras having a partially overlapping field of view. After receiving the image data, the interface circuit 200 may transmit the image data to the area determination circuit 300 for identification of the overlapping area.

For example, the interface circuit 200 receives a first image and a second image captured at different angles during a horizontal rotation process by the same camera having a partially overlapping field of view, and transmits the first image and the second image to the area determination circuit 300. Correspondingly, the area determination circuit 300 identifies the overlapping area between the first image and the second image. Further, the image stitching apparatus 100 may be the image stitching apparatus 100 provided by any of the embodiments of the present invention above.

In one embodiment, the interface circuit 200 acquires the first image from a first surveillance camera and acquires the second image from a second surveillance camera.

The present invention further provides an image stitching method. FIG. 16 shows a flowchart of an image stitching method according to an embodiment of the present invention. Referring to FIG. 16, the process of the image stitching method is as described below.

In step 510, motion detection is performed on an overlapping area between a first image and a second image that are to undergo stitching to obtain a motion area having a moving object in the overlapping area.

In step 520, a target stitching line is calculated using a constraint of avoiding the motion area.

In step 530, the first image and the second image are stitched according to the target stitching line to obtain a stitched image.

In one embodiment, the image stitching method provided by the present invention further includes calculating at least one difference matrix between the first image and the second image with respect to the overlapping area. Then, according to the difference matrix, the target stitching line is calculated using constraints of minimizing a difference between two sides of the stitching line and avoiding the motion area.

In one embodiment, the image stitching method provided by the present invention further includes calculating a previous stitching line, and then correcting a cost diagram according to the previous stitching line.

It should be noted that, details of the image stitching method may be referred from the description associated with the image stitching apparatus in the embodiments above, and are omitted herein.

The image stitching apparatus, image processing chip and image stitching method provided according to embodiments of the present invention are described in detail as above. The principles and implementations of the present invention are described by way of specific embodiments in the literature, and the description of the embodiments above is for helping to better understand the present invention. Moreover, modifications may be made to specific implementations and application ranges on the basis of the concept of the present invention by a person skilled in the art, and the contents of the description should not be construed as limitations to the present invention.

What is claimed is:

1. An image stitching apparatus, comprising:
a motion detection circuit, performing motion detection on an overlapping area between a first image and a second image to obtain a motion area having a moving object in the overlapping area;
a determination circuit, calculating a target stitching line in the overlapping area using a constraint of avoiding the motion area; and
a stitching circuit, stitching the first image and the second image according to the target stitching line to obtain a stitched image.

2. The image stitching apparatus according to claim 1, further comprising:
a difference calculation circuit, calculating at least one difference matrix between the first image and the second image with respect to the overlapping area;
wherein, the determination circuit calculates the target stitching line using the constraint of avoiding the motion area according to the at least one difference matrix.

3. The image stitching apparatus according to claim 2, wherein the difference calculation circuit calculates a plurality of difference matrices between the first image and the second image with respect to the overlapping area according to a plurality of different difference calculation methods.

4. The image stitching apparatus according to claim 2, wherein the difference calculation circuit comprises:
a color difference calculation circuit, calculating a color difference matrix between the first image and the second image with respect to the overlapping area;
an edge detector, performing edge detection on the first image and the second image with respect to the overlapping area to obtain a first edge detection result corresponding to the first image and a second edge detection result corresponding to the second image; and
an edge difference calculation circuit, calculating a difference according to the first edge detection result and the second edge detection result to obtain an edge difference matrix.

5. The image stitching apparatus according to claim 4, wherein the edge difference matrix and the color difference matrix have same shapes.

6. The image stitching apparatus according to claim 4, wherein the determination circuit comprises:
a data processing circuit, obtaining a cost diagram according to the color difference matrix, the edge difference matrix and the motion area; and
a stitching line calculation circuit, calculating the target stitching line according to the cost diagram.

7. The image stitching apparatus according to claim 6, wherein the stitching line calculation circuit accumulates, in an accumulation direction and using a constraint of minimizing an accumulation value, a plurality of elements and an element in adjacent elements of an adjacent row in the cost diagram to obtain the target stitching line.

8. The image stitching apparatus according to claim 6, wherein the stitching line calculation circuit accumulates, in the accumulation direction and using the constraint of minimizing the accumulation value, the plurality of elements in the cost diagram and an element in adjacent elements of a same row and the adjacent row to obtain the target stitching line.

9. The image stitching apparatus according to claim 2, further comprising:
a shift limiting circuit, generating a shift limit data according to a previous stitching line previously calculated by the determination circuit;
wherein, the determination circuit calculates the target stitching line using the constraint of avoiding the motion area according to the at least one difference matrix and the shift limit data.

10. The image stitching apparatus according to claim 1, wherein the motion detection circuit performs the motion detection on the first image with respect to the overlapping area according to a previous first image corresponding to the first image to obtain a first candidate motion area, performs the motion detection on the second image according to a previous second image corresponding to the second image to obtain a second candidate motion area, and merges the first candidate motion area and the second candidate motion area to obtain the motion area.

11. An image processing chip, comprising:
an interface circuit, receiving a first image and a second image;
an area determination circuit, determining an overlapping area between the first image and the second image; and
an image stitching apparatus, stitching the first image and the second image according to the overlapping area to obtain a stitching image, the image stitching apparatus comprising:
a motion detection circuit, performing motion detection on the overlapping area between the first image and the second image to obtain a motion area having a moving object in the overlapping area;
a determination circuit, calculating a target stitching line using a constraint of avoiding the motion area; and
a stitching circuit, stitching the first image and the second image according to the target stitching line to obtain a stitched image.

12. The image processing chip according to claim 11, wherein the interface circuit receives the first image from a first surveillance camera and receives the second image from a second surveillance camera.

13. The image processing chip according to claim 11, wherein the image stitching apparatus further comprises:
a difference calculation circuit, calculating at least one difference matrix between the first image and the second image with respect to the overlapping area;
wherein, the determination circuit calculates the target stitching line using the constraint of avoiding the motion area according to the at least one difference matrix.

14. The image processing chip according to claim 13, wherein the image stitching apparatus further comprises:
a shift limiting circuit, generating a shift limit data according to a previous stitching line previously calculated by the determination circuit;
wherein, the determination circuit calculates the target stitching line using the constraint of avoiding the motion area according to the at least one difference matrix and the shift limit data.

15. An image stitching method, comprising:
performing motion detection on an overlapping area between a first image and a second image to obtain a motion area having a moving object in the overlapping area;
calculating a target stitching line using a constraint of avoiding the motion area; and
stitching the first image and the second image according to the target stitching line to obtain a stitched image.

16. The image stitching method according to claim 15, further comprising:
calculating at least one difference matrix between the first image and the second image with respect to the overlapping area;
wherein, the step of calculating the target stitching line comprises:
calculating the target stitching line using the constraint of avoiding the motion area according to the at least one difference matrix.

17. The image stitching method according to claim 16, further comprising:
generating shift limit data according to a previously stitching line previously calculated;
wherein the step of calculating the target stitching line comprises:
calculating the target stitching line using the constraint of avoiding the motion area according to the at least one difference matrix and the shift limit data.

18. The image stitching method according to claim 16, wherein the step of calculating the least one difference matrix comprises:
calculating a color difference matrix between the first image and the second image with respect to the overlapping area;
performing edge detection on the first image and the second image with respect to the overlapping area to obtain a first edge detection result corresponding to the first image and a second edge detection result corresponding to the second image; and
calculating a difference according to the first edge detection result and the second edge detection result to obtain an edge difference matrix.
